(19) United States
(12) Patent Application Publication
(10) Pub. No.: US 2006/0069580 A1
(43) Pub. Date: Mar. 30, 2006

(54) Systems and methods for providing user status information

(76) Inventors: Andrew Mason, Sunnyvale, CA (US); Michael Sharland, Santa Clara, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/953,104

(22) Filed: Sep. 28, 2004

(51) Int. Cl. G06Q 99/00

(52) U.S. Cl. 705/1

(57) ABSTRACT

In some embodiments, systems and methods for providing user status information may include providing information associated with a description of a user status. According to some embodiments, a mouse-over of an icon associated with a user may cause a status and information describing the status to be displayed. In some embodiments, the information describing the status may be obtaining from an e-mail server.

### TECHNICAL FIELD

The present disclosure relates generally to systems and methods for providing user status information, and more particularly to systems and methods for providing information associated with a description of a user status.

### BACKGROUND

Users of communications systems (e.g., co-workers, family members, business contacts, and/or friends) are frequently on the move and may, at any given time, have access to various communication devices. To facilitate communications between users, many systems allow a user to define or set a status that indicates whether the user is available or not (e.g., available via a particular communication device). Other users may access this information in various ways. In e-mail systems, for example, an e-mail may be sent to the user and an automated “Out of Office Reply” may be sent back in response. In other systems, such as the OpenScape™ enterprise communications platform offered by Siemens®, an icon representing the user may indicate a status of the user (e.g., busy, out of office, or in a meeting).

In e-mail systems, a user may also be able to create a message that describes the user's status. In the automated “Out of Office Reply”, for example, a message from the user may be included. The message may describe why the user is out of the office, how long the user will be out of the office, other users that may be contacted while the user is unavailable, or other information describing the user's status. In order to access the status and the description information however, an e-mail must be sent to the user's account to actively solicit the automated status response (e.g., including the user's message). In other communication systems, only the user's status may be provided.

Accordingly, there is a need for systems and methods to provide user status information, and particularly to provide information associated with a description of a user status, that address these and other problems found in existing technologies.

### SUMMARY

Methods, systems, and computer program code are therefore presented for providing information associated with a description of a user status.

According to some embodiments, systems, methods, and computer code are operable to provide an icon associated with a user, receive an indication associated with a desire to view a status of the user, determine the status, retrieve information associated with a description of the status, and provide the status and the information associated with the description of the status.

According to some embodiments, systems, methods, and computer code may include a first database to store a status of a first user, and a server coupled to the first database. In some embodiments, the server may be operable to provide an icon representing the status, receive an indication of a mouse-over associated with the icon, retrieve information associated with a description of the status, and provide the information associated with the description of the status. Embodiments may further include an e-mail server coupled to the server and a second database to store the information associated with the description of the status.

With these and other advantages and features of embodiments that will become hereinafter apparent, embodiments may be more clearly understood by reference to the following detailed description, the appended claims and the drawings attached herein.

### BRIEF DESCRIPTION OF THE DRAWINGS

FIG. 1 is a block diagram of a communication system;

FIG. 2 is a block diagram of a communication system;

FIG. 3 is a screen diagram of a communication system interface;

FIG. 4 is a block diagram of a system according to some embodiments;

FIG. 5 is a flowchart of a method according to some embodiments;

FIG. 6 is a screen diagram of an exemplary system interface according to some embodiments; and

FIG. 7 is a block diagram of a system according to some embodiments.

### DETAILED DESCRIPTION

Some embodiments herein are associated with a “status” or a “status of a user”. As used herein, the term “status” may generally refer to any information and/or data that is indicative of, represents, describes, and/or is otherwise associated with an attribute, posture, position, and/or other status. The “status of a user” may, for example, include information associated with a location, activity, presence, and/or other attribute of a user. In some embodiments, the status of a user may be or include a descriptor associated with an availability of the user (e.g., with respect to communications and/or with respect to a particular user device) As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a PDA, a storage device (e.g., a disk drive), a hub, a router, a switch, and a modem or a wireless phone. User and network devices may comprise one or more communication or network components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network devices. By way of example, a network may be configured to operate in accordance with the Fast Ethernet Local Area Network (LAN) transmission standard 802.3-2002® published by the Institute of Electrical and Electronics Engineers (IEEE). In some embodiments, a network may include one or more wired and/or wireless networks operated in accordance with any communication standard that is or becomes known or practicable.

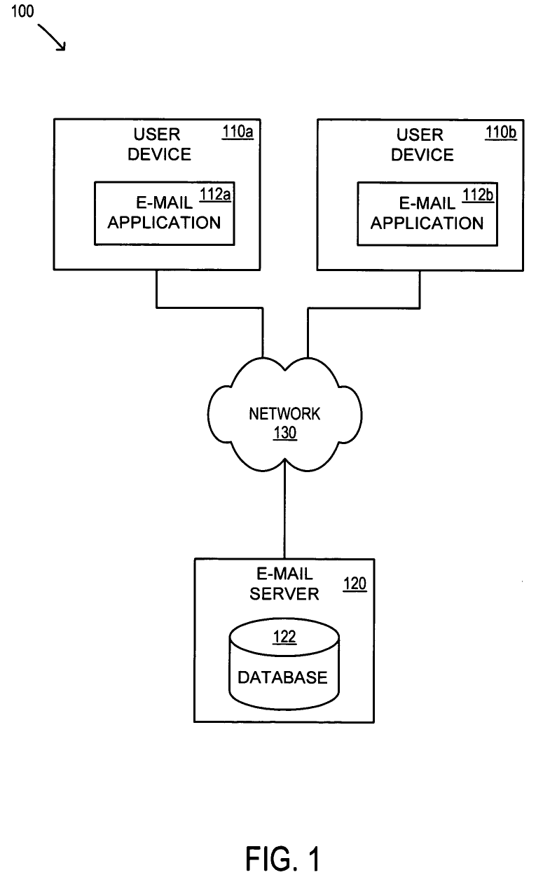

Referring first to FIG. 1, a block diagram of a communication system 100 is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may include, for example, one or more user devices 110a-b that may operate e-mail applications 112a-b. The system 100 may also include an e-mail server 120 and/or a database 122 (e.g., within the e-mail server 120). Any or all of the user device 110a-b and/or the e-mail server 120 may be in communication and/or otherwise coupled. In some configurations, one or more of the user devices 110a-b, the e-mail server 120, the e-mail applications 112a-b, and/or the database 122, may communicate via a network 130. Fewer or more components than are shown in FIG. 1 may be included in the system 100.

The system 100 may, for example, be an e-mail system that allows the status and/or status description associated with a user to be provided to other users upon solicitation. The first user device 110a may be owned and/or operated by a first user. The first user may, in some configurations, utilize the e-mail application 112a running on the first user device 110a to interface with the e-mail server 120. The first user may, for example, utilize the first user device 110a to input information associated with the first user's status.

As an example, the first user may be going on vacation and may wish to set their status to “Out of Office”, as well as provide a message describing why the first user will be out of the office (e.g., “I will be on vacation during the first week of July”). The first user's e-mail application 112a may be used to enter the desired status information, and the status information may be provided and/or sent to the e-mail server 120. The e-mail server 120 may, in some configurations, store the first user's status information in the database 122.

In the system 100, if a second user desires to communicate with and/or determine the status of the first user, the second user must send an e-mail (e.g., using the second user device 110b) to the e-mail server 120 (e.g., that manages the e-mail account of the first user). The e-mail server 120 may then, in some configurations, determine the status that has been set by the first user. In the case that the first user has not indicated a particular status and/or has indicated that the first user is available, for example, the e-mail server 120 may provide the second user's e-mail to the first user (e.g., the e-mail from the second user device 110b may be sent and/or provided to the first user device 110a). In some configurations, a notification that the e-mail was received by either or both of the e-mail server 120 and the first user device 110a may be provided to the second user device 110b.

In the case that the first user has indicated that the first user is unavailable (e.g., “Out of Office”), the e-mail server 120 may send an automated “Out of Office Reply” to the second user device 110b (e.g., in response to the second user's e-mail). The e-mail server 120 may, for example, create an e-mail that includes the message and/or description of the first user's status that was defined or created by the first user (e.g., “I will be on vacation during the first week of July”). Accordingly, in order to discover the status of the first user and/or in order to be provided access to the first user's status description or message, the second user must actively solicit the e-mail server 120 (e.g., by sending an attempted e-mail communication to the first user device 110a). In some cases, because the status and/or status description associated with the first user is unavailable to other users prior to attempting to communicate with the first user device 110a, other users may waste time by sending e-mail messages that cannot be answered because the recipient (e.g., the first user) is unavailable.

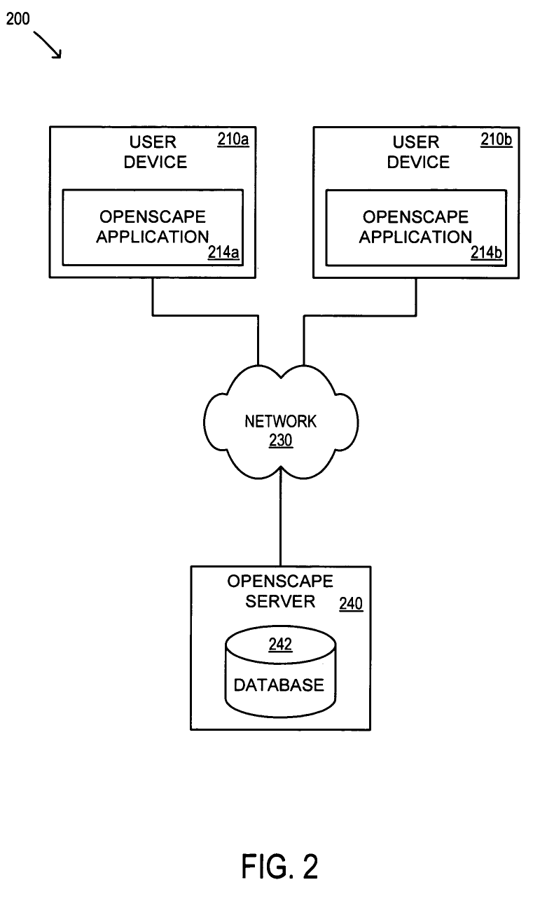

Turning now to FIG. 2, a block diagram of a communication system 200 is shown. The system 200 may, for example, be or include an enterprise communications system such as Siemens® OpenScape™. In the case that the system 200 is or includes OpenScape™, the system 200 may be configured to reduce communications overhead such as by reducing the occurrence of communications being sent to users and/or user devices that are unavailable. In some configurations, fewer or more components than are shown in FIG. 2 may be included in the system 200. According to some configurations, different types, layouts, quantities, and configurations of systems may be used.

The system 200 may include, for example, one or more user devices 210a-b that may operate OpenScape™ applications 214a-b and/or that may communicate via a network 230. The system 200 may also include an OpenScape™ server 240 and/or a database 242 (e.g., within the OpenScape™ server 240). Any or all of the user device 210a-b and/or the OpenScape™ server 240 may be in communication and/or otherwise coupled. In some configurations, one or more of the user devices 210a-b, the OpenScape™ server 240, the OpenScape™ applications 214a-b, and/or the database 242, may communicate via the network 230. In some embodiments, the components 210a-b, 230 of the system 200 may be similar in configuration and/or functionality to the similarly-named components described in conjunction with FIG. 1.

The system 200 may, for example, be an OpenScape™ and/or other enterprise communication system that allows the status associated with a user to be provided to other users. The first user device 210a may be owned and/or operated by a first user. The first user may, in some configurations, utilize the OpenScape™ application 214a running on the first user device 210a to interface with the OpenScape™ server 240. The first user may, for example, utilize the first user device 210a to input information associated with the first user's status.

As an example, the first user may be going on vacation and may wish to set their status to “Out of Office”. The first user's OpenScape™ application 214a may be used to enter the desired status information, and the status information may be provided and/or sent to the OpenScape™ server 240. The OpenScape™ server 240 may, in some configurations, store the first user's status information in the database 242. Other users, such as a second user utilizing the second user device 210b may then, for example, access the first user's status via the OpenScape™ server 240.

The second user may utilize the OpenScape™ application 214b operated by the second user device 210b, for example, to access the OpenScape™ server 240. In some configurations, the OpenScape™ server 240 may provide the status of the first user to the second user without requiring the second user to attempt to communicate the first user. The second user may not be required, for example, to actively solicit the first user's status information by sending an e-mail to the first user. The OpenScape™ server 240 may, according to some configurations, provide an icon representing the first user. The icon may, for example, be provided to the second user device 210b and/or may be displayed by the OpenScape™ application 214b operating on the second user device 210b.

In such a manner, for example, the second user may be able to simply view the icon associated with the first user to determine the user's status. Accordingly, the second user may be less likely to waste time by sending an e-mail (or other communication) to the first user in the case that the first user is unavailable. In some configurations, the OpenScape™ server 240 and/or the OpenScape™ applications 214a-b may provide the users with an interface that may be utilized to interact with the OpenScape™ server 240 (e.g., to set the user's own status) and/or to view the status information of other users. The interface may include, for example, a Graphical User Interface (GUI) that includes icons representing users of the communication system 200.

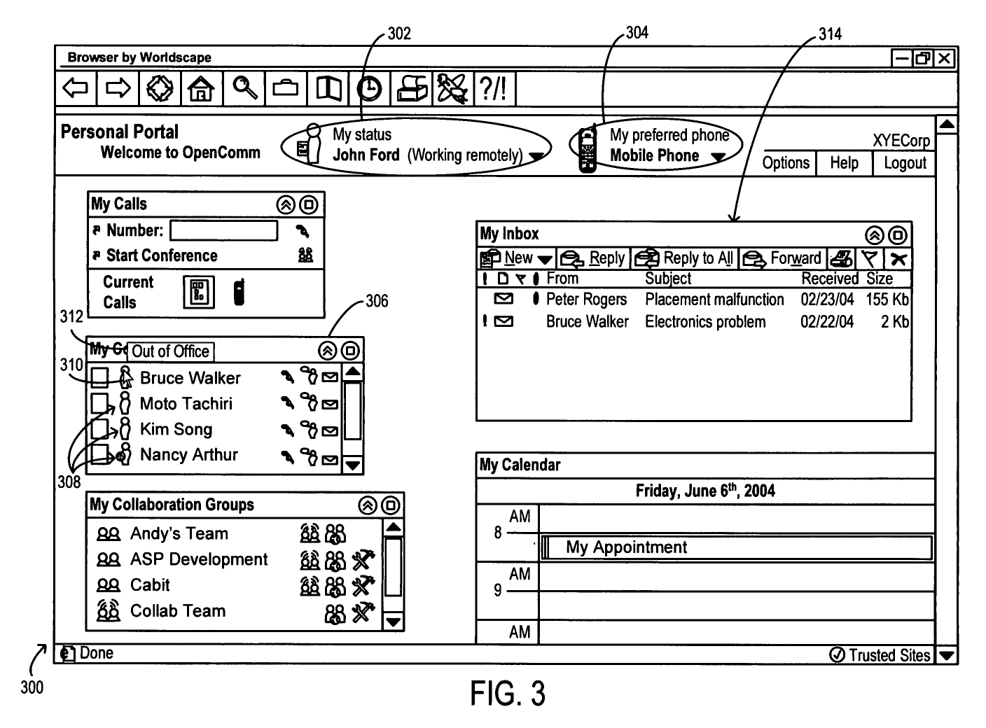

Turning to FIG. 3, for example, a screen diagram of a communication system interface 300 is shown. The interface 300 may, for example, be or include an interface associated with an enterprise communications system such as Siemens® OpenScape™. The interface 300 may, according to some configurations, be an interface associated with the communication system 200 described in conjunction with FIG. 2 herein. In some configurations, fewer or more components than are shown in FIG. 3 may be included in the interface 300. According to some configurations, different types, layouts, quantities, and configurations of interfaces may be used.

The interface 300 may, for example, be or include a communications system GUI that facilitates communication between users. As shown in FIG. 3, the interface 300 may be operated by a particular user 302 (e.g., “John Ford”). The user 302 may utilize the interface 300 to, for example, set and/or define a status of the user 302, and/or indicate one or more user devices (such as the user devices 110a-b, 210a-b) that are desirable or preferred user devices 304 for use in contacting the user 302. In such a manner for example, other users of the communication system may be able to use the GUI to view the status of the user 302 and any preferred user devices 304 that should be used to communicate with the user 302.

The user 302 may, as shown in FIG. 3, be presented with a “Contacts” section 306 of the interface 300. The Contacts section 306 may include, for example, icons 308 representing various users (e.g., of the communication system associated with the interface 300). The Contacts section 306 may also include other information and/or icons. In some configurations, the icons 308 may indicate the status of the represented users. In some configurations, the icons 308 may directly and/or indirectly indicate the status of the associated users.

For example, the icon 308 for a particular user may change color and/or configuration based on the status of the user, and/or interaction with the icon 308 may cause the status of the user to be displayed. As shown in FIG. 3, for example, when the user 302 operating the interface 300 causes a mouse cursor 310 to overlap an icon 308, a status 312 (e.g., “Out of Office”) of the user associated with the icon 308 (e.g., the user “Bruce Walker”) may be displayed. This may allow a user 302 of the interface 300, for example, to easily view the status of other users and/or user groups including co-workers, family, business contacts, and friends. The user 302 of the interface 300 may thus not be required to actively solicit the status of another user by, for example, sending an e-mail to the other user.

In some configurations, although the user 302 may not be required to send an e-mail to another user in order to determine the status of the other user, the interface 300 may provide an e-mail section 314 that allows the user 302 to utilize e-mail functions. The interface 300 may, for example, allow the user 302 to interact with an enterprise communication system as well as access a separate e-mail system (e.g., via the e-mail section 314). In some configurations, the e-mail system may be incorporated into the enterprise communication system, and the e-mail section 314 may not provide access to a separate application and/or system. The user 302 may, for example, utilize the e-mail section 314 to send an e-mail to another user after the user 302 has utilized the interface 300 to determine that the other user is available (and presumably available via an e-mail-enabled user device).

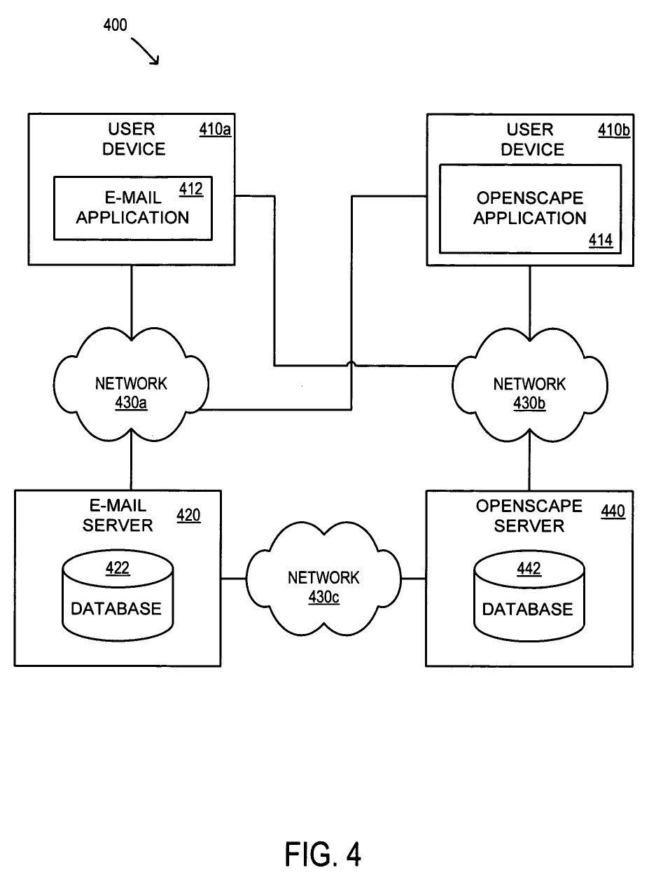

Turning now to FIG. 4, a block diagram of a system 400 according to some embodiments is shown. The system 400 may, for example, be associated with the systems 100, 200 and/or the interface 300 described in conjunction with any of FIG. 1, FIG. 2, and/or FIG. 3. According to some embodiments, the system 400 may be or include a combination of the systems 100, 200 and/or the system components described in conjunction with FIG. 1 and FIG. 2 herein. In some embodiments, fewer or more components than are shown in FIG. 4 may be included in the system 400. According to some embodiments, different types, layouts, quantities, and configurations of systems may be used.

The system 400 may include, for example, a first user device 410a that operates an e-mail application 412 and/or a second user device 410b that operates an OpenScape™ application 414. Other user devices 410 and/or applications 412, 414 may be included in the system 400 according to some embodiments. The user devices 410a-b may, for example, each operate both an e-mail application 412 and an OpenScape™ application 414 (as well as other types of applications). In some embodiments, the system 400 may also or alternatively include an e-mail server 420 and/or a database 422 (e.g., operated on and/or by the e-mail server 420). According to some embodiments, the system 400 may include a network 430. The network 430 may, for example, include multiple networks, network segments, network components, and/or network types or configurations (such as the networks 430a-c). An OpenScape™ server 440 and/or a database 442 (e.g., operated on and/or by the OpenScape™ server 440) may also or alternatively be included within the system 400.

In some embodiments, any or all of the components 410a-b, 412, 414, 420, 422, 440, 442 of the system 400 may be in communication and/or otherwise coupled. The components 410a-b, 412, 414, 420, 422, 440, 442 may, for example, be in communication via the various sub-networks 430a-c as shown in FIG. 4. According to some embodiments, the components 410a-b, 412, 414, 420, 422, 430a-c, 440, 442 of the system 400 may be similar in configuration and/or functionality to the similarly-named components described in conjunction with any of FIG. 1 and/or FIG. 2 herein.

In the system 400 a first user operating the first user device 410a may, for example, utilize the e-mail application 412 to interface with the e-mail server 420 (e.g., via the network 430a). According to some embodiment, the first user may be going out for lunch and may wish to have their unavailability status automatically provided to any other user that e-mails the first user. Accordingly, the first user may set their status to “Out to Lunch” and this status may be provided to the e-mail server 420. In some embodiments, the e-mail server 420 may store the first user's status information in the database 422.

According to some embodiment, the first user may also or alternatively create, identify, and/or otherwise provide information associated with a description of the user's status. For example, the first user may utilize the e-mail application 412 to create an “Out of Office Reply” message that is to be displayed and/or provided to other users that send e-mails to the first user (i.e., while the first user is unavailable). In some embodiments, the information associated with the description of the user's status may include any information relating to the user's status. According to some embodiments, the e-mail server 420 may store the status description information in the database 422. In the case that an e-mail directed to the first user is received while the first user is unavailable, for example, the e-mail server 420 may utilize the stored status information and/or status description information to automatically reply to the received e-mail. In other words, the status information and/or status description information may be provided to another user that attempts to contact the first user while the first user is unavailable.

In some embodiments, the first user may also or alternatively interface with the OpenScape™ server 440. According to some embodiments, the first user may define, establish, and/or set the user's status and/or status description information by interfacing with the e-mail server 420 as described herein. The first user may also or alternatively utilize the first user device 410a and/or an OpenScape™ application 414 operated by the first user device 410a (not shown), to set the user's status on the OpenScape™ server 440. For example, the first user may access the OpenScape™ server 440 via the network 430b. According to some embodiment, the OpenScape™ server 440 may provide an interface (such as the interface 300) to the first user device 410a. The first user may utilize the interface to set the user's status within OpenScape™ to an appropriate unavailable status (such as “Out to Lunch”).

Any other user, such as a second user utilizing the second user device 410b, may have access to either or both of the e-mail server 420 (e.g., via the network 430a) and the OpenScape™ server 440 (e.g., via the network 430b). In some embodiments, the second user may desire to communicate with the first user. The second user may, for example, utilize the OpenScape™ application 414 to interface with the OpenScape™ server 440. The OpenScape™ server 440 may, according to some embodiments, provide the second user with an interface (such as a GUI) via which the second user may have access to information associated with the first user.

For example, the second user may view an icon associated with the first user. The icon may, according to some embodiments, represent the first user's status in any form or manner that is or becomes known or practicable. In some embodiments, the second user may indicate that the second user is interested in determining the status of the first user. The second user may, for example, position a mouse cursor over the icon representing the first user, click the icon (e.g., with a mouse pointer), select an option from a menu, and/or otherwise provide an indication. According to some embodiments, the indication provided by the first user may be sent (e.g., from the second user device 410b and/or the OpenScape™ application 414) to the OpenScape™ server 440.

In some embodiments, the OpenScape™ server 440 may provide the status of the first user in response to the indication. The OpenScape™ server 440 may, for example, provide the status set by the first user within OpenScape™ (e.g., “Out to Lunch”). According to some embodiments, the OpenScape™ server 440 may also or alternatively provide the information associated with the description of the first user's status that the first user provided to the e-mail server 420. For example, the OpenScape™ server 440 may communicate with the e-mail server 420 (e.g., via the network 430c) to obtain the status description information. In some embodiments, the OpenScape™ server 440 may query the database 422 of the e-mail server 420 to determine, identify, retrieve, and/or otherwise obtain the status description information. The OpenScape™ server 440 may, according to some embodiments, store the status description information in the database 442. Other storage devices such as cache and/or Random Access Memory (RAM) may also or alternatively be used to store the status and/or status description information.

According to some embodiments, the OpenScape™ server 440 may query the e-mail server 420 for the status description information in the case that an indication is received from the second user. In some embodiments, the OpenScape™ server 440 may obtain the status description information in the case that the status of the first user is changed within OpenScape™. The status and/or status description information associated with the first user may, for example, be provided to the second user (e.g., by the OpenScape™ server 440) dynamically and/or in real-time. The second user may, for example, be able to view both the status and the status description information associated with the first user without having to actively solicit the information by attempting to contact the first user. In such a manner, according to some embodiments, the second user is less likely to waste time attempting to contact a user that is unavailable.

In some embodiments, the system 400 may include a single network 430 by which the various components 410a-b, 412, 414, 420, 422, 440, 442 may communicate. The various networks 430a-c shown in FIG. 4, for example, may be or include the same network. In some embodiments, any or all of the various networks 430a-c may comprise different networks, network paths, network configurations, and/or network types. For example, the first network between the first user device 410a and the e-mail server 420 may include an Internet Protocol (IP) network such as the Internet and/or a LAN. In some embodiments, the first network 430a may be or include a Public Switched Telephone Network (PSTN), such as in the case that the first user utilizes a dial-up connection to the e-mails server 420.

According to some embodiments, either or both of the second network 430b and the third network 430c may be configured similarly to the first network 430a. In some embodiments, the second network 430b may include a corporate network such as a LAN and/or a Wide-Area Network (WAN). The communication between the e-mail server 420 and the OpenScape™ server 440 via the third network 430c may include any type of communication that is or becomes known or practicable. The third network 430c may, for example, be or include an Infrared Radiation (IR), Radio Frequency (RF), Bluetooth™, microwave, satellite, IP, and/or PSTN network. In some embodiments, such as in the case that the system 400 is operated by a single corporate entity, the third network 430c may be or include a cable, port, and/or other connection or path. The e-mail server 420 and the OpenScape™ server 440 may, for example, be directly connected and/or coupled (e.g., in the case that they are physically located in proximity to one another).

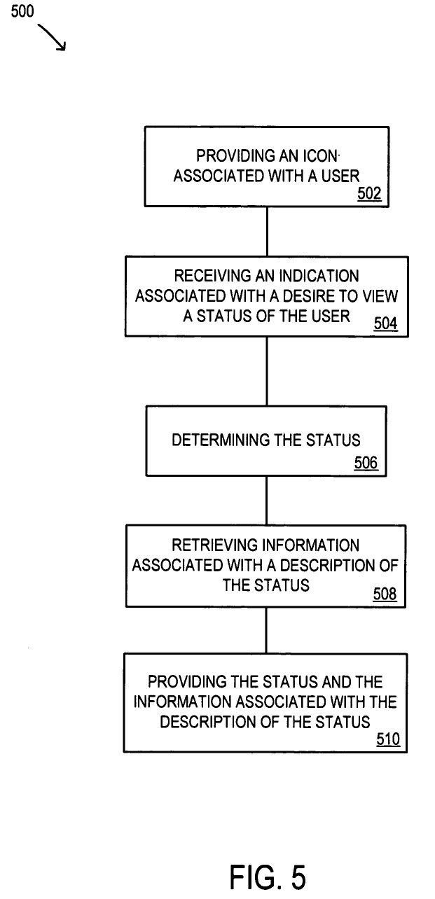

Turning now to FIG. 5, a method 500 according to some embodiments is shown. In some embodiments, the method 500 may be conducted by and/or by utilizing the systems 100, 200, 400 and/or may be otherwise associated with the systems 100, 200, 400 and/or any of the system components described in conjunction with any of FIG. 1, FIG. 2, and/or FIG. 4. The method 500 may also or alternatively be associated with the interface 300 described in conjunction with FIG. 3 herein. In some embodiments, the method 500 may be performed by and/or otherwise associated with computational and/or logic device or application such as the OpenScape™ server 240, 440 or the OpenScape™ application 214, 414 described herein.

According to some embodiments, the method 500 may begin at 502 by providing an icon associated with a user. The icon may, for example, be any type and/or configuration of graphical and/or visual object that is representative of a user and/or an attribute of a user. In some embodiments, the icon may include a screen icon in a GUI, a word, a letter, a phrase, a hyperlink, and/or any other type or configuration of visual expression. According to some embodiments, the icon may be provided by an OpenScape™ server and/or application to a user device. The icon may, for example, be displayed on a user's screen. In some embodiments, multiple icons may be provided and/or displayed. Icons representing each user in a “buddy list”, workgroup, newsgroup, business, corporation, and/or family may, for example be displayed via a GUI.

The method 500 may continue, for example, by receiving an indication associated with a desire to view a status of the user, at 504. In some embodiments, the indication may be received from a user device operated by a user. The indication may, for example, include an input provided by a user. According to some embodiments, the indication may include a mouse click, a mouse-over, a cursor movement, a keyboard input, a touch screen input, a menu item selection, and/or any other type of input that is or becomes known or practicable. An OpenScape™ server and/or application may, for example, receive an indication of a mouse-over of the icon provided at 502. In other words, a user may mouse-over the icon to indicate a desire to view the status of the user associated with the icon.

According to some embodiments, the icon may inherently indicate the status and no indication may be required to indicate a desire to view the status (e.g., the user may have access to the status automatically). In such embodiments, the indication may represent a desire to view status description information associated with the user. For example, although the icon may indicate the status of the associated user (e.g., via one or more colors, graphics, and/or sounds), a user may mouse-over the icon to provide an indication that more information (e.g., information associated with a description of the status) regarding the status is desired.

In some embodiments, the method 500 may continue at 506 by determining the status. An OpenScape™ server and/or application may, for example, access a database (such as the database 242, 442) to retrieve the status information associated with the desired user. In the case that a user positions a mouse pointer over an icon associated with a user (e.g., providing an indication that is received at 504), for example, the status may also be provided. In some embodiments, the status may be determined upon receipt of the indication, ion accordance with one or more time intervals, and/or based upon any other timing and/or scheduling that is or becomes practicable.

The method 500 may continue, according to some embodiments, at 508 by retrieving information associated with a description of the status. An OpenScape™ server and/or application may, for example, access an e-mail and/or other server associated with a user in order to determine the information associated with the description of the user's status. In some embodiments, the status description information may be determined, identified, retrieved, and/or otherwise received. The status description information may, for example, be a message and/or other text, graphic, audio, and/or video that is defined and/or created by the user.

According to some embodiments, the status description information may be information associated with an automated “Out of Office Reply” message stored by an e-mail server and/or e-mail application (e.g., “Call Bob at extension 2567 while I am away”). In some embodiments, the status description information may be retrieved from a database (such as the database 222, 422), a list, and/or a file, via a lookup, query, and/or other request or search. The OpenScape™ server and/or application may, for example, utilize a programmatic interface, a query language such as the Structured Query Language (SQL) and/or a derivation thereof, and/or any other type of request or query interface and/or tool that is or becomes known or practicable. In some embodiments, the retrieval of the status description information may be performed dynamically, such as in the case that an indication is received and/or in the case that a user's status is determined to have changed. The status description information may also or alternatively be queries and/or retrieved based on any other time interval and/or query strategy or method that is or becomes known or practicable.

In some embodiments, the method 500 may continue by providing the status and the information associated with the description of the status, at 510. The status determined at 506 and the status description information retrieved at 508 may, for example, be provided to a user that has provided an indication of interest (e.g., that is received at 504). According to some embodiments, the status and status description information may be displayed on a user device. In some embodiments, the user device via which the status and status description information are displayed may be a user device that provided the indication received at 504. The information may also or alternatively be provided in any manner and/or form that is or becomes known or practicable. In some embodiments, the status and/or status description information may be provided via a GUI that may, for example, be displayed and/or executed on a user device.

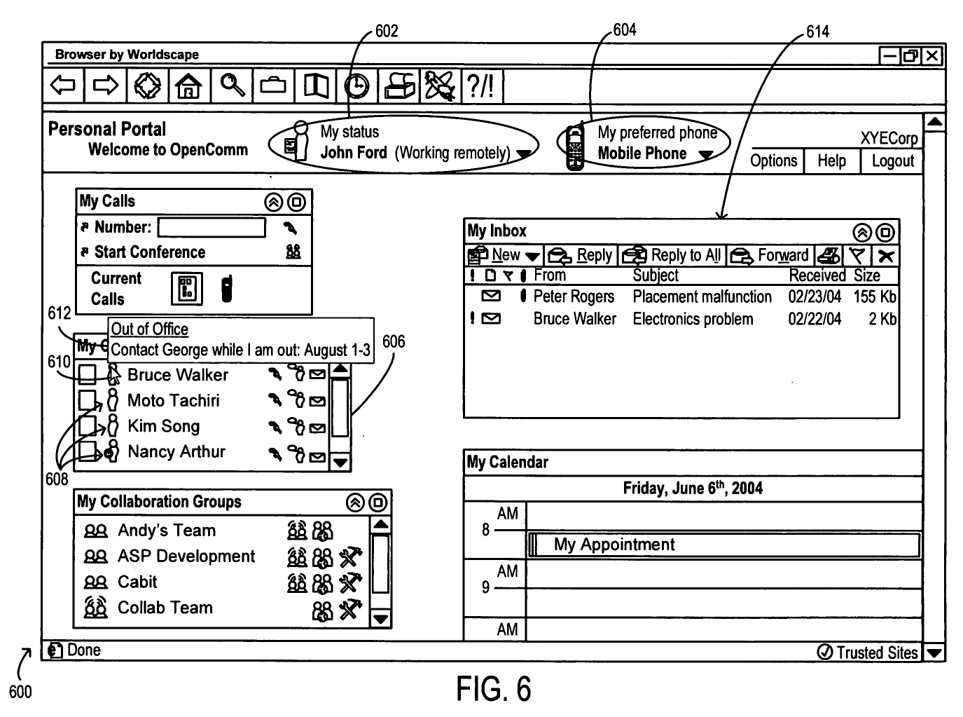

Turning to FIG. 6, for example, a screen diagram of an exemplary system interface 600 according to some embodiments is shown. The interface 600 may, for example, be or include an interface associated with an enterprise communications system such as Siemens® OpenScape™. The interface 600 may, according to some embodiments, be an interface associated with the systems 200, 400 described in conjunction with any of FIG. 2 and/or FIG. 4 herein. The interface 600 may also or alternatively be configured to conduct, facilitate, and/or otherwise be associated with the method 500 described in conjunction with FIG. 5 herein. In some configurations, fewer or more components than are shown in FIG. 6 may be included in the interface 600. According to some configurations, different types, layouts, quantities, and configurations of interfaces may be used.

The interface 600 may, for example, be or include a communications system GUI that facilitates communication between users. In some embodiments (such as shown in FIG. 6), the interface 600 may operated by a user 602 and may include areas defining one or more preferred devices 604 associated with the user 602 and/or a list of contacts 606. The list of contacts 606 may, for example, include icons 608 representing the various contacts. According to some embodiments, the user 602 of the interface 600 may utilize a mouse pointer 610 to indicate a desire to view status and/or status-related information associated with a particular user (or user group). The interface 600 may, for example, display status information 612 in response to the indication from the user 602. In some embodiments, the interface 600 may also or alternatively provide an e-mail area 614 via which the user 602 may send and/or receive e-mail.

In some embodiments, the components 602, 604, 606, 608, 610, 612, 614 of the system 600 may be similar in configuration and/or functionality to the similarly-named components described in conjunction with FIG. 3 herein. The interface 600 may, for example, be similar to an interface utilized and/or provided by an OpenScape™ server and/or application. According to some embodiments, the interface 600 may provide more information than the interface 300 described herein. For example, the interface 600 may provide both the status and status description information associated with a user within the status information 612.

According to some embodiments, the user 602 may not be required to send an e-mail to another user (e.g., using the e-mail area 614) in order to discover the status and/or status description information (e.g., the status information 612) associated with the other user. In some embodiments, the ability to receive this information prior to attempting to contact the other user may reduce the amount of communication overhead that the user 602 must endure. For example, in the case that the user 602 desires to contact “Bruce Walker”, the user 602 may typically be required to send an e-mail to Bruce (and/or initiate another form of communication). If Bruce is unavailable, then the communication attempt by the user 602 may be unsuccessful. If the communication attempt was made via e-mail, the user 602 may receive an automated “Out of Office Reply” stating that Bruce is unavailable and/or describing Bruce's unavailability.

According to some embodiments, the interface 600 may be utilized by the user 602 to quickly and/or easily determine Bruce's status. The user 602 may, for example, be able to distinguish, simply by viewing the icon 608 associated with Bruce, that Bruce is unavailable. In some embodiments, Bruce's unavailability may be specific to one or more user devices. For example, if Bruce is out of the office, Bruce may be unavailable via Bruce's office phone and/or office computer, but may be available via another preferred device 604 such as a cell phone, laptop, or PDA.

In some embodiments, the availability of Bruce's status may be likely to prevent the user 602 from wasting time attempting communications (e.g., to Bruce's office phone) that may not be answered. According to some embodiments, the user 602 may desire information in addition to Bruce's status. For example, once the user 602 determines that Bruce is “Out of Office” (e.g., by viewing the icon 608 and/or by performing a mouse-over of the icon 608), the user 602 may need to determine whether to attempt to reach Bruce via another user device such as the preferred device 604 or whether to wait until Bruce's return.

According to some embodiments, the user 602 may perform a mouse-over of the icon 608 to view both status and status description information associated with Bruce. For example, upon performing the mouse-over of the icon 608, the status information 612 may be displayed. In some embodiments, the status description information (e.g., “Contact George while I am away: August 1-3”) may be retrieved from an e-mail system and/or server (e.g., as interfaced with via the e-mail area 614). The status description information may be or include, for example, a message (such as shown in FIG. 6) that has been created by Bruce to describe and/or provide more information regarding Bruce's status.

In some embodiments, the user 602 may utilize the status description information to determine whether to attempt to contact Bruce or whether to wait until his return. If the user 602 requires timely resolution of an issue, for example, then the user may contact “George” (e.g., as per Bruce's message). If the status description information was not provided by the interface 600, the user 602 may waste time by waiting for Bruce to return, not knowing that someone else (e.g., George) may be available in Bruce's stead. Thus, some embodiments reduce the amount of wasted time that the user 602 may otherwise endure in attempting to communicate with other users.

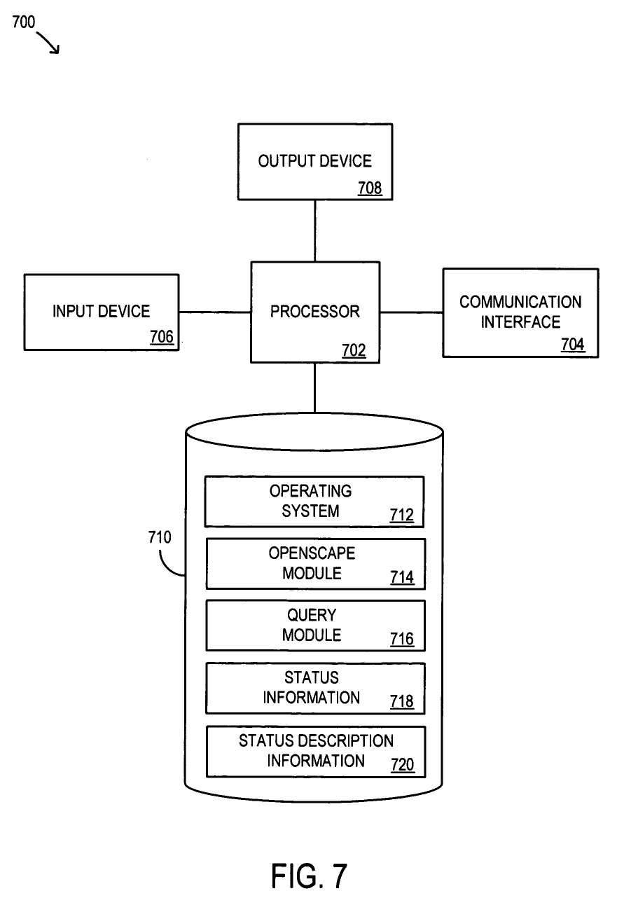

Turning now to FIG. 7, a block diagram of a system 700 according to some embodiments is shown. The system 700 may, for example, be utilized to implement and/or perform the method 500 described herein and/or may be associated with the systems 100, 200, 400 and/or the interfaces 300, 600 described in conjunction with any of FIG. 1, FIG. 2, FIG. 3, FIG. 4, FIG. 5, and/or FIG. 6. In some embodiments, fewer or more components than are shown in FIG. 7 may be included in the system 700. According to some embodiments, different types, layouts, quantities, and configurations of systems may be used.

In some embodiments, the system 700 may be or include a computer device such as a PC, a workstation, a PDA, and/or a server. According to some embodiments, the system 700 may be an enterprise or corporate server such as the OpenScape™ server 240, 440 described herein. In some embodiments, the system 700 may be a communication system (such as the system 400) that is used to provide both status and status description information to users. The system 700 may include, for example, one or more processors 702, which may be any type or configuration of processor, microprocessor, and/or micro-engine that is or becomes known or available. In some embodiments, the system 700 may also or alternatively include a communication interface 704, an input device 706, an output device 708, and/or a memory device 710, all and/or any of which may be in communication with the processor 702. The memory device 710 may store, for example, an operating system 712, an OpenScape™ module 714, a query module 716, status information 718, and/or status description information 720.

The communication interface 704, the input device 706, and/or the output device 608 may be or include any types and/or configurations of devices that are or become known or available. According to some embodiments, the input device 706 may include a keyboard, a keypad, one or more buttons, an interface (such as a GUI), and/or one or more softkeys and/or variable function input devices. The input device 706 may include, for example, any input component of a server and/or client-side server application or user device.

The memory device 710 may be or include, according to some embodiments, one or more magnetic storage devices, such as hard disks, one or more optical storage devices, and/or solid state storage. The memory device 710 may store, for example, the operating system 712 and/or the OpenScape™ module 714, either or both of which may, for example, include instructions that cause the processor 702 to operate the system 700 in accordance with embodiments as described herein. The memory device 710 may also or alternatively store the query module 716, the status information 718, and/or the status description information 720. In some embodiments, the memory device 710 may be similar to and/or include the database 242, 442 described herein.

The OpenScape™ module 714 may, for example, be or include any type of program, software, firmware, microcode, module, procedure, and/or other instructions that are operable to provide the status information 718 and the status description information 720 to one or more users. The OpenScape™ module 714 may, according to some embodiments, implement and/or facilitate the method 500 described herein. In some embodiments, the OpenScape™ module 714 may also or alternatively include instructions associated with providing and/or operating an interface such as the interfaces 300, 600 described herein. The OpenScape™ module 714 may, for example, provide a GUI to a user that gives the user access to the status information 718 and the status description information 720.

The query module 716 may be or include any type or configuration of instructions and/or devices that allow the system 700 to access the status description information 720. The query module 716 may, for example, include a programmatic interface and/or a query interface that allows the system 700 to retrieve information from an e-mail and/or other server (e.g., via the communication interface 704). For example, the query module 716 may allow the system 700 to access an e-mail server database (such as the database 222, 422) to retrieve and/or identify an “Out of Office Reply” message defined by a user.

According to some embodiments, the status information 718 may include information defining and/or representing the status of a user. The status information 718 may, for example, include textual description of various possible user states such as “Out of Office”, “Out to Lunch”, “Available”, “Busy”, etc. In some embodiments, the status information 718 may be set, established, and/or defined by the user. The user may, for example, interface with the system 700 to define the user's status. The status description information 720 may be or include any information relating to the status of the user. The status description information 720 may, for example, include any automated messages and/or status descriptions entered by a user into an e-mail system, server, and/or application. According to some embodiments, the system 700 may provide the status description information 720 to a user to reduce the overhead associated with communications between users. Having access to the status description information 720 prior to initiating a communication attempt may, for example, allow the user to more effectively manage and/or utilize time spent communicating with co-workers, business contacts, family, and/or friends.

The examples described herein have, for ease of explanation, involved providing e-mail system status description information to users of the OpenScape™ enterprise communications system. It should be understood however, that other applications and/or communications systems may be substituted for those described herein without deviating from the scope and/or purpose of some embodiments. The OpenScape™ communication system, as used herein, may be any type and/or configuration of application that is capable of providing status and status description information to users. In some embodiments, for example, a word-processing application may provide the status and status description information to a user. Similarly, any application and/or system that stores and/or allows a user to define status description information may provide such information to the OpenScape™ and/or other communication system or application. According to some embodiments, a spreadsheet, database, project management, and/or other informational application may provide the status description information.

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
providing an icon associated with a user;
receiving an indication associated with a desire to view a status of the user;
determining the status;
retrieving information associated with a description of the status; and
providing the status and the information associated with the description of the status.

2. The method of claim 1, further comprising:
storing the information associated with the description of the status.

3. The method of claim 1, wherein determining the status comprises:
receiving an indication defining the status.

4. The method of claim 3, wherein the indication defining the status includes an indication changing the status.

5. The method of claim 4, wherein the retrieving is performed at least in part in response to the change in the status.

6. The method of claim 1, wherein the indication includes a mouse-over of the icon.

7. The method of claim 1, wherein the indication includes a click of the icon.

8. The method of claim 1, wherein the information associated with the description of the status is retrieved from an e-mail server.

9. The method of claim 1, wherein the information associated with the description of the status is retrieved from an e-mail application.

10. The method of claim 1, wherein the retrieving of the information associated with the description of the status comprises:
querying a database associated with an e-mail server.

11. The method of claim 1, wherein the information associated with the description of the status includes a message composed by the user.

12. The method of claim 1, wherein the retrieving is performed at least in part in response to the indication.

13. The method of claim 1, wherein the information associated with the description of the status is provided as a pop-up information box within a graphical user interface.

14. A system, comprising:
a first database to store a status of a first user; and
a server coupled to the first database, wherein the server is to:
provide an icon representing the status;
receive an indication of a mouse-over associated with the icon;
retrieve information associated with a description of the status; and
provide the information associated with the description of the status.

15. The system of claim 14, further comprising:
an e-mail server coupled to the server, comprising:
a second database to store the information associated with the description of the status.

16. The system of claim 15, wherein the information associated with the description of the status is retrieved from the second database.

17. The system of claim 15, further comprising:
a first user device coupled to the e-mail server, wherein the first user device is to provide the information associated with the description of the status to the e-mail server.

18. The system of claim 17, wherein the information associated with the description of the status is provided to the e-mail server by an e-mail application executed by the first user device.

19. The system of claim 17, further comprising:
a second user device coupled to the server, wherein the second user device is to:
provide the indication of the mouse-over to the server; and
display the icon and the information associated with the description of the status.

20. A system, comprising:
a memory configured to store instructions;
a communication port; and
a processor coupled to the memory and the communication port, the processor being configured to execute the stored instructions to:
provide an icon associated with a user;
receive an indication associated with a desire to view a status of the user;
determine the status;
retrieve information associated with a description of the status; and
provide the status and the information associated with the description of the status.
